(19) United States
(12) Patent Application Publication
(10) Pub. No.: US 2022/0225033 A1
(43) Pub. Date: Jul. 14, 2022

(54) OPTICAL FIBER SENSING SYSTEM, OPTICAL FIBER SENSING DEVICE, AND SOUND OUTPUT METHOD

(71) Applicant: NEC Corporation, Minato-ku, Tokyo (JP)

(72) Inventor: Takashi KOJIMA, Tokyo (JP)

(73) Assignee: NEC Corporation, Minato-ku, Tokyo (JP)

(21) Appl. No.: 17/612,631

(22) PCT Filed: May 29, 2019
(86) PCT No.: PCT/JP2019/021210

§ 371 Date: Nov. 19, 2021

(51) Int. Cl. H04R 23/00; H04B 10/25

(52) U.S. Cl. CPC H04R 23/008; H04B 10/25

(57) ABSTRACT

An optical fiber sensing system according to the present disclosure comprises: an optical fiber (10) configured to transmit an optical signal with sound superimposed thereon; a conversion unit (21) configured to convert the optical signal into acoustic data; and an output unit (22) configured to output the sound on the basis of the acoustic data.

### TECHNICAL FIELD

The present disclosure is related to an optical fiber sensing system, an optical fiber sensing device, and a sound output method.

### BACKGROUND ART

In recent years, a technology called optical fiber sensing has been known, that uses an optical fiber as a sensor to detect sound. Since an optical fiber enables superimposition of sound on an optical signal transmitted therethrough, detection of sound is made possible through use of an optical fiber.

For example, Patent Literature 1 discloses a technology of detecting sound by analyzing a phase change of an optical wave transmitted through an optical fiber.

### CITATION LIST

### Patent Literature

### Patent Literature 1

Published Japanese Translation of PCT International Publication for Patent Application, No. 2010-506496

### SUMMARY OF INVENTION

### Technical Problem

Incidentally, as an acoustic system configured to output sound such as a person's voice, an acoustic system configured to employ a microphone and to output sound collected by the microphone has been generally known.

However, a typical microphone requires configuration such as arrangement and connection according to an acoustic system that employs the microphone and circumstances of the use. For example in a case in which the acoustic system is a conference system, it is required to provide a microphone (a plurality of microphones as the case may be), and, according to the number of participants and a seating plan of the conference, to change the position(s) of the microphone(s) and organize electrical cables connected to the microphone(s). Therefore, the acoustic system that employs a microphone is cumbersome to configure and difficult to construct flexibly.

On the other hand, an optical fiber, which enables detection of sound as described above, is provided with a function corresponding to a sound collection function of a microphone.

However, the technology disclosed in Patent Literature 1 does little more than detect the sound from the optical wave transmitted through the optical fiber, and does not encompass the concept of outputting the detected sound itself.

Given this, an objective of the present disclosure is to provide an optical fiber sensing system, an optical fiber sensing device, and a sound output method that solve the aforementioned problems and enable flexible constitution of an acoustic system.

### Solution to Problem

An optical fiber sensing system according to an aspect comprises: an optical fiber configured to transmit an optical signal with sound superimposed thereon; a conversion unit configured to convert the optical signal into acoustic data; and an output unit configured to output the sound on the basis of the acoustic data.

A sound output method according to an aspect comprises: a transmitting step in which an optical fiber transmits an optical signal with sound superimposed thereon; a conversion step of converting the optical signal into acoustic data; and an output step of outputting the sound on the basis of the acoustic data.

### Advantageous Effects of Invention

The above-described aspects provide an effect of providing an optical fiber sensing system, an optical fiber sensing device, and a sound output method that enable flexible constitution of an acoustic system.

### BRIEF DESCRIPTION OF DRAWINGS

FIG. 1 is a diagram showing a configuration example of an optical fiber sensing system according to a first example embodiment.

FIG. 2 is a flow chart showing an operation example of the optical fiber sensing system according to the first example embodiment.

FIG. 3 is a diagram showing a configuration example of a modification of the optical fiber sensing system according to the first example embodiment.

FIG. 4 is a diagram showing a configuration example of an optical fiber sensing system according to a second example embodiment.

FIG. 5 is a diagram showing an example of a procedure of identifying a position of production of sound in the optical fiber sensing system according to the second example embodiment.

FIG. 6 is a diagram showing an example of notification of the position of production of sound in the optical fiber sensing system according to the second example embodiment.

FIG. 7 is a diagram showing another example of notification of the position of production of sound in the optical fiber sensing system according to the second example embodiment.

FIG. 8 is a flow chart showing an operation example of the optical fiber sensing system according to the second example embodiment.

FIG. 9 is a diagram showing an example of notification of a position of production of sound and a type of a sound source in the optical fiber sensing system according to a third example embodiment.

FIG. 10 is a flow chart showing an operation example of the optical fiber sensing system according to the third example embodiment.

FIG. 11 is a diagram showing a configuration example of an optical fiber sensing system according to a fourth example embodiment.

FIG. 12 is a diagram showing an example of notification of a position of production of sound and a type of a sound source in the optical fiber sensing system according to the fourth example embodiment.

FIG. 13 is a diagram showing a configuration example of an optical fiber sensing system according to a fifth example embodiment.

FIG. 14 is a diagram showing a configuration example of a modification of the optical fiber sensing system according to the fifth example embodiment.

FIG. 15 is a diagram showing a configuration example of another modification of the optical fiber sensing system according to the fifth example embodiment.

FIG. 16 is a diagram showing a configuration example of a conference system according to a first application example.

FIG. 17 is a diagram showing an example of notification of an ON/OFF status of a microphone in the conference system according to the first application example.

FIG. 18 is a diagram showing an example of a laying procedure of an optical fiber in a conference system according to a second application example.

FIG. 19 is a diagram showing another example of the laying procedure of an optical fiber in the conference system according to the second application example.

FIG. 20 is a diagram showing still another example of the laying procedure of an optical fiber in the conference system according to the second application example.

FIG. 21 is a diagram showing yet another example of the laying procedure of an optical fiber in the conference system according to the second application example.

FIG. 22 is a diagram showing an example of a connecting procedure of an optical fiber in the conference system according to the second application example.

FIG. 23 is a diagram showing an example of arrangement in a conference room at a site X in the conference system according to the second application example.

FIG. 24 is a diagram showing a first display example of display output of the position of production of sound and the type of the sound source in the conference system according to the second application example.

FIG. 25 is a diagram showing an example of a correspondence table used in the first display example in the second application example.

FIG. 26 is a diagram showing an example of a procedure of obtaining names of participants seated in chairs in the first display example in the second application example.

FIG. 27 is a diagram showing a second display example of display output of the position of production of sound and the type of the sound source in the conference system according to the second application example.

FIG. 28 is a diagram showing a third display example of display output of the position of production of sound and the type of the sound source in the conference system according to the second application example.

FIG. 29 is a diagram showing a modification of the conference system according to the second application example.

FIG. 30 is a diagram showing an example of a correspondence table used in the modification of the conference system according to the second application example.

FIG. 31 is a block diagram showing an example of a hardware configuration of a computer embodying an optical fiber sensing device according to the example embodiments.

### DESCRIPTION OF EMBODIMENTS

Hereinafter, example embodiments of the present disclosure are described with reference to the drawings. Note that the following descriptions and the drawings involve omissions and simplifications as appropriate for the sake of clarification of explanation. In addition, in each of the following drawings, the same element is denoted by the same symbol and repeated explanation is omitted as needed.

### First Example Embodiment

First, with reference to FIG. 1, a configuration example of an optical fiber sensing system according to a first example embodiment is described.

As shown in FIG. 1, the optical fiber sensing system according to the first example embodiment is provided with an optical fiber 10 and an optical fiber sensing device 20. In addition, the optical fiber sensing device 20 is provided with a conversion unit 21 and an output unit 22.

The optical fiber 10 is laid in a predetermined area. For example, in a case of applying the optical fiber sensing system to a conference system, the optical fiber 10 is laid in a predetermined area in a conference room. The predetermined area in the conference room is, for example, a table, a floor, walls, a ceiling, or the like in the conference room. Alternatively, in a case of applying the optical fiber sensing system to a monitoring system, the optical fiber 10 is laid in a predetermined monitoring area to be monitored. The predetermined monitoring area is, for example, a border, a prison, a commercial facility, an airport, a hospital, a street, a port, a plant, a nursing home, a company premise, a nursery school, a private home, or the like. Note that the optical fiber 10 may be laid in the predetermined area in a form of an optical fiber cable obtained by covering the optical fiber 10.

The conversion unit 21 emits pulsed light into the optical fiber 10. The conversion unit 21 also receives, as return light, reflected light and scattered light generated while the pulsed light is transmitted through the optical fiber 10, via the optical fiber 10.

When sound is produced around the optical fiber 10, the sound is superimposed on the return light transmitted by the optical fiber 10. The optical fiber 10 can thus detect the sound produced around the optical fiber 10.

The conversion unit 21 converts the return light with the sound superimposed thereon received from the optical fiber 10 into acoustic data. The conversion unit 21 can be embodied by using, for example, a distributed acoustic sensor (DAS).

The output unit 22 outputs the sound on the basis of the acoustic data converted by the conversion unit 21. For example, the output unit 22 carries out acoustic output of the sound from a speaker (not illustrated) or the like, or display output of the sound on a monitor (not illustrated) or the like. In the case of display output of the sound, the output unit 22 may, for example, carry out voice recognition of the sound and output a result of the voice recognition as characters.

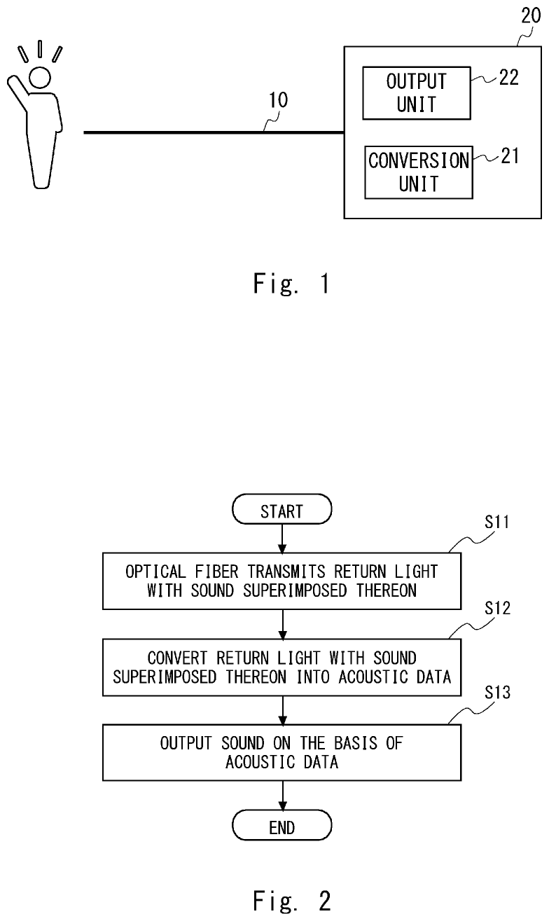

Subsequently, with reference to FIG. 2, an operation example of the optical fiber sensing system according to the first example embodiment is described.

As shown in FIG. 2, when sound is produced around the optical fiber 10, the optical fiber 10 superimposes the sound on the return light transmitted through the optical fiber 10 (Step S11).

The conversion unit 21 receives the return light with the sound superimposed thereon from the optical fiber 10, and converts the return light into acoustic data (Step S12).

Thereafter, the output unit 22 outputs the sound on the basis of the acoustic data converted by the conversion unit 21 (Step S13).

As described above, according to the first example embodiment: the optical fiber 10 superimposes the sound produced around the optical fiber 10 on the return light (optical signal) transmitted through the optical fiber 10 to transmit the sound; the conversion unit 21 converts the return light with the sound superimposed thereon into the acoustic data; and the output unit 22 outputs the sound on the basis of the acoustic data.

As a result, the sound detected by the optical fiber 10 can be reproduced in the output unit 22 in a separate location. In this regard, the optical fiber 10 is capable of detecting sound in any location where the optical fiber 10 is laid, and can thus be used as a microphone. At this time, the optical fiber 10 detects sound in a linear manner, unlike the typical microphone that detects sound in a pinpoint manner. Consequently, there is no need for arranging the typical microphone according to circumstances of the use and connecting the microphone to an electrical cable, whereby configuration is facilitated. In addition, the optical fiber 10 can be laid over a broad area inexpensively and easily. Therefore, employing the optical fiber sensing system of the first example embodiment enables flexible configuration of the acoustic system.

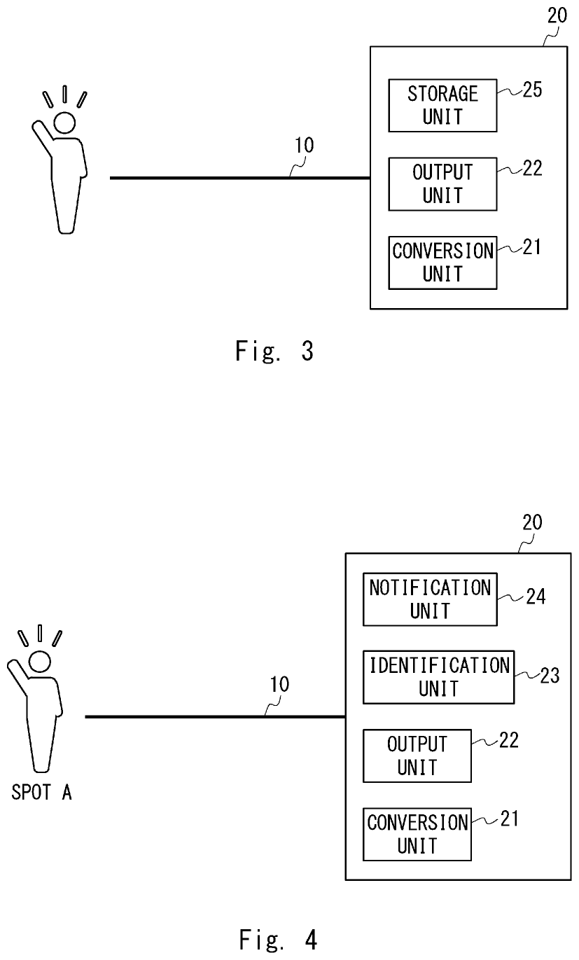

Note that, in the first example embodiment, the acoustic data may be stored and then the sound may be output on the basis of the acoustic data thus stored. In such a case, as shown in FIG. 3, the optical fiber sensing device 20 is further provided with a storage unit 25. In this case, the conversion unit 21 stores the acoustic data in the storage unit 25, and the output unit 22 reads the acoustic data from the storage unit 25 and outputs the sound on the basis of the acoustic data thus read.

### Second Example Embodiment

Subsequently, with reference to FIG. 4, a configuration example of the optical fiber sensing system according to the second example embodiment is described.

As shown in FIG. 4, the optical fiber sensing system according to the second example embodiment is different from the configuration of FIG. 1 of the first example embodiment in that the optical fiber sensing device 20 is provided with an identification unit 23 and a notification unit 24.

On the basis of the return light with the sound superimposed thereon received by the conversion unit 21, the identification unit 23 identifies the position of production of the sound (a distance of the optical fiber 10 from the position to the conversion unit 21).

For example, on the basis of a time difference between the clock time at which the conversion unit 21 emits the pulsed light into the optical fiber 10 and the clock time at which the conversion unit 21 receives the return light with the sound superimposed thereon, the identification unit 23 identifies the distance of the optical fiber 10 from the position of production of the sound to the conversion unit 21. In this regard, if the identification unit 23 holds in advance a correspondence table in which the distance of the optical fiber 10 is associated with the position (spot) corresponding to the distance, the position of production of the sound (in this case, spot A) may also be identified through use of the correspondence table.

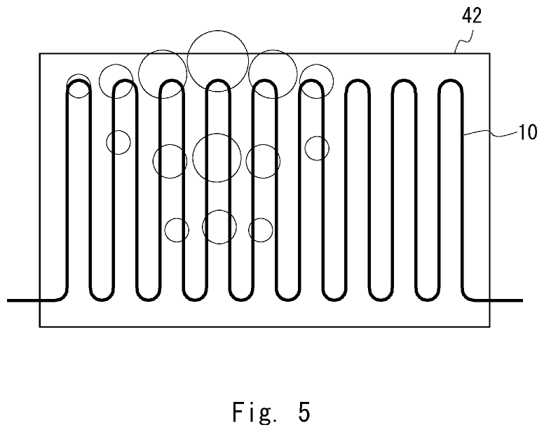

Alternatively, the identification unit 23 may also compare intensity of the sound detected at positions corresponding to predetermined distances of the optical fiber 10 from the conversion unit 21, to identify the position of production of the sound (a distance of the optical fiber 10 from the position to the conversion unit 21) on the basis of the result of the comparison. For example, suppose that the intensity of sound is detected at predetermined distances of the optical fiber 10, which is laid evenly over a table 42 as shown in FIG. 5. In the example shown in FIG. 5, the intensity of sound is indicated by the size of circles, of which greater size indicates more intense sound. In this case, the identification unit 23 identifies the position of production of the sound according to a distribution of the intensity of the sound.

Note that when an event producing sound occurs around the optical fiber 10, vibration is likely to accompany the occurrence of the event. The vibration is also superimposed on the return light transmitted by the optical fiber 10. The optical fiber 10 can thus also detect the vibration generated with the sound around the optical fiber 10.

Consequently, the identification unit 23 may also identify the distance of the optical fiber 10 from the position of production of the sound to the conversion unit 21 on the basis of a time difference between the clock time at which the conversion unit 21 emits the pulsed light into the optical fiber 10 and the clock time at which the conversion unit 21 receives the return light with the vibration generated with the sound superimposed thereon. In this case, the conversion unit 21 can be embodied by using a distributed vibration sensor (DVS). The use of the distributed vibration sensor also enables the conversion unit 21 to convert the return light with the vibration superimposed thereon into vibration data.

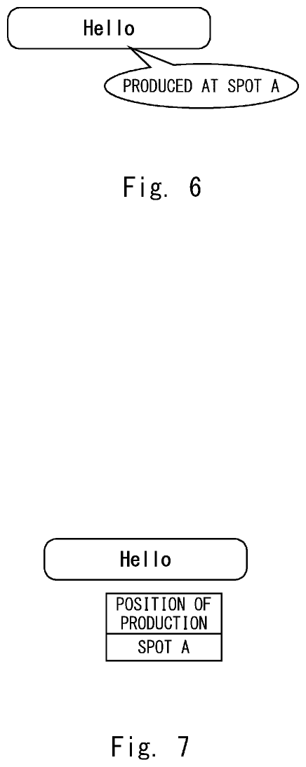

The notification unit 24 notifies, when the output unit 22 outputs the sound, a position of production as the position of production of the sound, in association with the sound that the output unit 22 outputs. For example, as shown in FIG. 6 and FIG. 7, when the output unit 22 carries out display output of the sound, the notification unit 24 carries out display output of the position of production of the sound (in this case, spot A) together with the sound subjected to display output by the output unit 22. Note that, although both the sound and the position of production thereof are subjected to display output in FIG. 6 and FIG. 7, the present disclosure is not limited thereto. For example, the output unit 22 may carry out acoustic output of the sound and the notification unit 24 may carry out display output of the position of production of the sound.

Note that when the optical fiber sensing device 20 is configured to store the acoustic data in the storage unit 25 (see FIG. 3), the identification unit 23 may also store the position of production of the sound in the storage unit 25 in association with the acoustic data. In this case, when the output unit 22 outputs the sound, the notification unit 24 reads the position of production of the sound from the storage unit 25 and notifies the position of production of the sound thus read in association with the sound that the output unit 22 outputs.

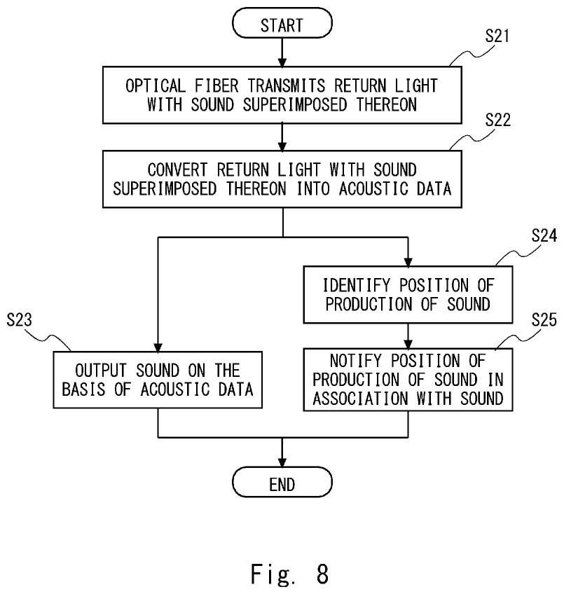

Subsequently, with reference to FIG. 8, an operation example of the optical fiber sensing system according to the second example embodiment is described.

As shown in FIG. 8, the processes of Steps S21 to S23 are identical to the processes of Steps S11 to S13 shown in FIG. 2.

On the other hand, the identification unit 23 identifies the position of production of the sound superimposed on the return light received from the optical fiber 10 (Step S24).

The notification unit 24 notifies, when the output unit 22 outputs the sound in Step S23, the position of production identified by the identification unit 23 as the position of production of the sound, in association with the sound that the output unit 22 outputs (Step S25).

As described above, according to the second example embodiment, the identification unit 23 identifies the position of production of the sound superimposed on the return light received from the optical fiber 10, and the notification unit 24 notifies, when the output unit 22 outputs the sound, the position of production identified by the identification unit 23 as the position of production of the sound, in association with the sound that the output unit 22 outputs.

As a result, upon output of the sound detected by the optical fiber 10, the position of production of the sound can be notified. Other effects are identical to those of the first example embodiment described above.

### Third Example Embodiment

The optical fiber sensing system according to the third example embodiment is the same in configuration as FIG. 4 of the second example embodiment described above, with the function of the identification unit 23 being extended.

The audio data converted by the conversion unit 21 has an intrinsic pattern according to the type (for example, person, animal, robot, heavy machinery, etc.) of the sound source of the sound on which the acoustic data is based.

Consequently, the identification unit 23 is capable of identifying the type of the sound source of the sound on which the acoustic data is based, by analyzing a dynamic change in the pattern of the acoustic data.

Furthermore, when the type of the sound source is person, the pattern of the acoustic data of voice of the person is different from person to person.

Consequently, the identification unit 23 is capable of identifying, not only that the type of the sound source is person, but also which person is the sound source by analyzing a dynamic change in the pattern of the acoustic data.

At this time, the identifying unit 23 may identify the person through use of pattern matching for example. In particular, the identification unit 23 holds in advance acoustic data of voice of the person as teacher data for each of a plurality of persons. Note that the teacher data may also have been learned by the identification unit 23 through machine learning or the like. The identification unit 23 compares the pattern of the acoustic data converted by the conversion unit 21 with each of the patterns of the plurality of pieces of the teacher data held in advance. When a pattern of any of the teacher data is matched, the identification unit 23 identifies that the acoustic data converted by the conversion unit 21 is the acoustic data of voice of the person corresponding to the matched teacher data.

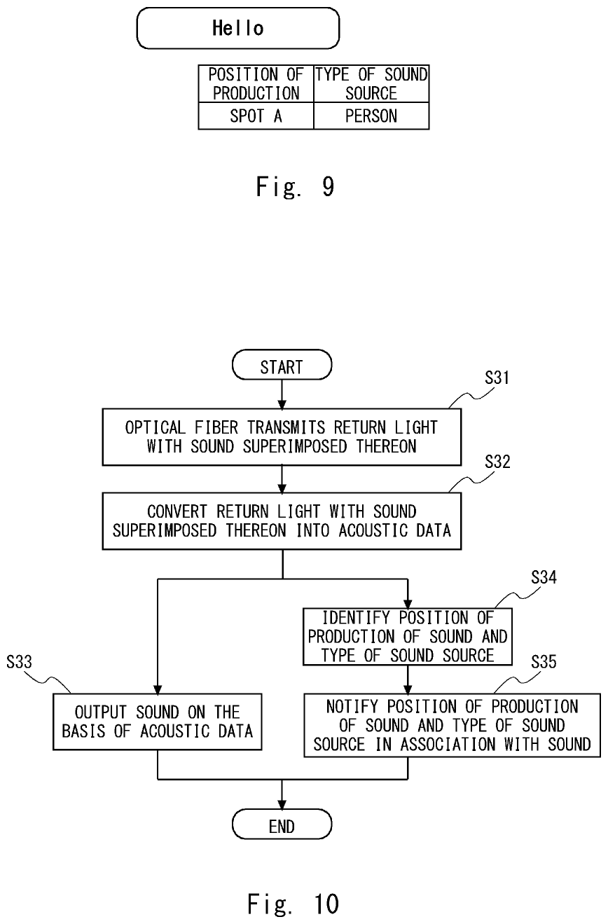

The notification unit 24 notifies, when the output unit 22 outputs the sound, the position of production and the type of the sound source identified by the identification unit 23 as the position of production of the sound and the type of the sound source of the sound in association with the sound that the output unit 22 outputs. For example, as shown in FIG. 9, when the output unit 22 carries out display output of the sound, the notification unit 24 carries out display output of the position of production of the sound (in this case, spot A) and the type of the sound source (in this case, person), together with the sound subjected to display output by the output unit 22. Note that, although the sound, the position of production thereof, and the type of the sound source are all subjected to display output in FIG. 9, the present disclosure is not limited thereto. For example, the output unit 22 may carry out acoustic output of the sound and the notification unit 24 may carry out display output of the position of production of the sound and the type of the sound source.

Note that when the optical fiber sensing device 20 is configured to store the acoustic data in the storage unit 25 (see FIG. 3), the identification unit 23 may also store the position of production of the sound and the type of the sound source in the storage unit 25, in association with the acoustic data. In this case, when the output unit 22 outputs the sound, the notification unit 24 reads the position of production of the sound and the type of the sound source from the storage unit 25 and notifies the position of production of the sound and the type of the sound source thus read in association with the sound that the output unit 22 outputs.

Subsequently, with reference to FIG. 10, an operation example of the optical fiber sensing system according to the third example embodiment is described.

As shown in FIG. 10, the processes of Steps S31 to S33 are identical to the processes of Steps S11 to S13 shown in FIG. 2.

On the other hand, the identification unit 23 identifies the position of production of the sound superimposed on the return light received from the optical fiber 10, and identifies the type of the sound source of the sound (Step S34).

The notification unit 24 notifies, when the output unit 22 outputs the sound in Step S33, the position of production and the type of the sound source identified by the identification unit 23 as the position of production of the sound and the type of the sound source of the sound, in association with the sound that the output unit 22 outputs (Step S35).

As described above, according to the third example embodiment, the identification unit 23 identifies the position of production of the sound superimposed on the return light received from the optical fiber 10, and identifies the type of the sound source of the sound, and the notification unit 24 notifies, when the output unit 22 outputs the sound, the position of production and the type of the sound source identified by the identification unit 23 as the position of production of the sound and the type of the sound source of the sound, in association with the sound that the output unit 22 outputs.

As a result, upon output of the sound detected by the optical fiber 10, the position of production of the sound and the type of the sound source of the sound can be notified. Other effects are identical to those of the first example embodiment described above.

### Fourth Example Embodiment

Subsequently, with reference to FIG. 11, a configuration example of the optical fiber sensing system according to the fourth example embodiment is described.

As shown in FIG. 11, the optical fiber sensing system according to the fourth example embodiment is the same in configuration as FIG. 4 of the second and third example embodiments described above, with the function of the identification unit 23 being extended.

In other words, the identification unit 23 identifies, regarding each of a plurality of pieces of sound from different positions of production, the position of production of the sound and the type of the sound source of the sound.

The example of FIG. 11 is an example in which sound is produced in each of two spots A and B. In the example of FIG. 11, the spot B is closer to the conversion unit 21 than the spot A. Consequently, the conversion unit 21 first receives the return light with the sound produced at the spot B superimposed. Then, the identification unit 23 identifies the position of production (in this case, the spot B) of the sound produced at the spot B and identifies the type of the sound source of the sound (in this case, robotic cleaner). Subsequently, the conversion unit 21 receives the return light with the sound produced at the spot A superimposed. Then, the identification unit 23 identifies the position of production (in this case, the spot A) of the sound produced at the spot A and identifies the type of the sound source of the sound (in this case, person).

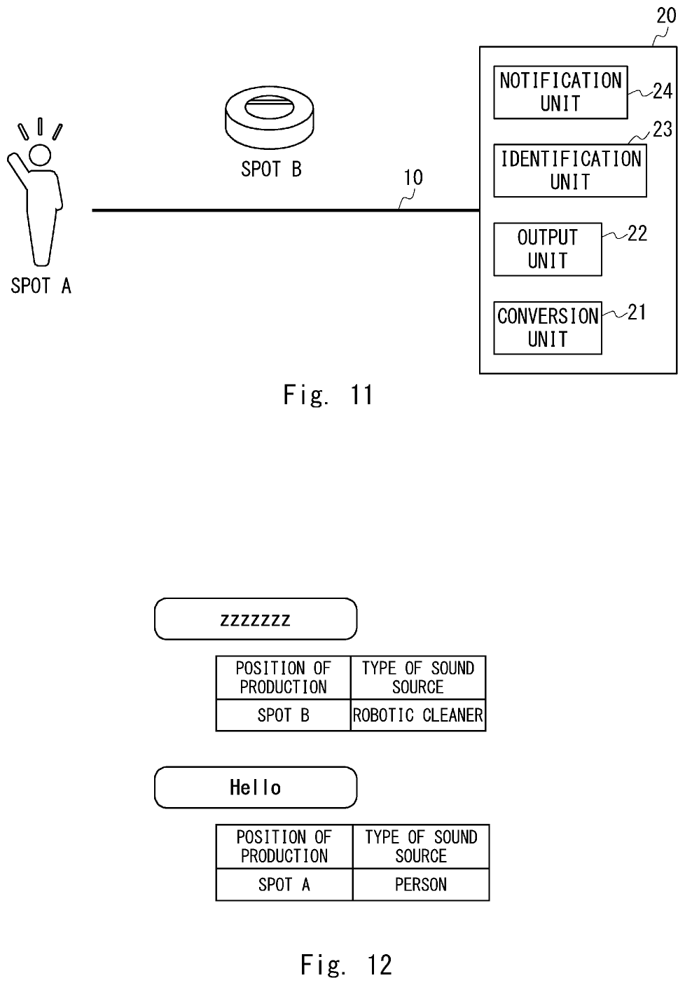

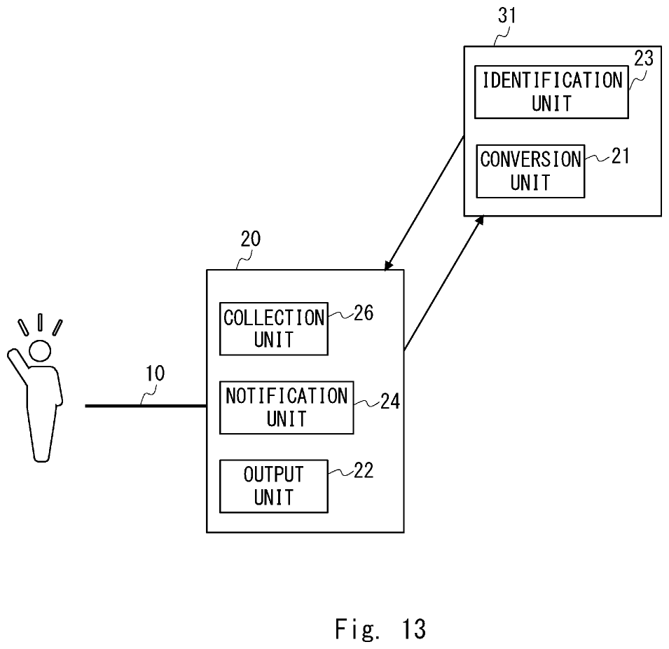

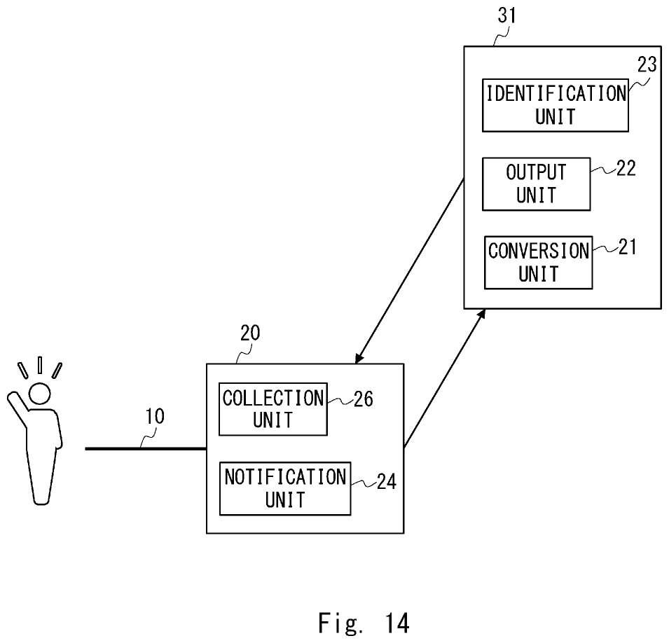

The notification unit 24 notifies, when the output unit 22 outputs the sound, the position of production and the type of the sound source identified by the identification unit 23 as the position of production of the sound and the type of the sound source of the sound, in association with the sound that the output unit 22 outputs. For example, as shown in FIG. 12, when the output unit 22 carries out display output of the sound produced at the spot B, the notification unit 24 carries out display output of the position of production of the sound (in this case, spot B) and the type of the sound source (in this case, robotic cleaner) together with the sound subjected to display output by the output unit 22. And when the output unit 22 carries out display output of the sound produced at the spot A, the notification unit 24 carries out display output of the position of production of the sound (in this case, spot A) and the type of the sound source (in this case, person) together with the sound subjected to display output by the output unit 22. Note that in FIG. 12, the latest sound is subjected to display output in the lowermost position. In addition, although the sound, the position of production thereof, and the type of the sound source are all subjected to display output in FIG. 12, the present disclosure is not limited thereto. For example, the output unit 22 may carry out acoustic output of the sound and the notification unit 24 may carry out display output of the position of production of the sound and the type of the sound source.

Note that in the fourth example embodiment, processes of Steps S32 and later in FIG. 10 may be carried out for each of the plurality of pieces of sound from different positions of production. Description of an operation example of the optical fiber sensing system according to the fourth example embodiment is therefore omitted herein.

As described above, according to the fourth example embodiment, the identification unit 23 identifies, regarding each of a plurality of pieces of sound from different positions of production, the position of production of the sound and the type of the sound source of the sound, and the notification unit 24 notifies, regarding each of the plurality of pieces of sound, when the output unit 22 outputs the sound, the position of production and the type of the sound source identified by the identification unit 23 as the position of production of the sound and the type of the sound source of the sound, in association with the sound that the output unit 22 outputs.

As a result, regarding each of the plurality of pieces of sound from different positions of production detected by the optical fiber 10, the position of production of the sound and the type of the sound source of the sound can be notified upon output of the sound. Other effects are identical to those of the first example embodiment described above.

### Fifth Example Embodiment

Subsequently, with reference to FIG. 13, a configuration example of the optical fiber sensing system according to the fifth example embodiment is described.

As shown in FIG. 13, the optical fiber sensing system according to the fifth example embodiment is different from the configuration of FIG. 4 of the second to fourth example embodiments in that the conversion unit 21 and the identification unit 23, which were provided in the optical fiber sensing device 20, are provided in a separate device (analysis device 31), and that a collection unit 26 is provided in the optical fiber sensing device 20.

The collection unit 26 emits the pulsed light into the optical fiber 10 and receives, as return light (including return light with sound and vibration superimposed thereon), reflected light and scattered light generated while the pulsed light is transmitted through the optical fiber 10, via the optical fiber 10. The optical fiber sensing device 20 transmits the return light received at the collection unit 26 to the analysis device 31.

In the analysis device 31, the conversion unit 21 converts the return light into the acoustic data, and the identification unit 23 identifies the position of production and the type of the sound source of the sound. The analysis device 31 transmits the acoustic data converted by the conversion unit 21 and the position of production and the type of the sound source of the sound identified by the identification unit 23 to the optical fiber sensing device 20.

In the optical fiber sensing device 20, the output unit 22 outputs the sound on the basis of the acoustic data converted by the conversion unit 21, and the notification unit 24 notifies the position of production and the type of the sound source of the sound identified by the identification unit 23 in association with the sound that the output unit 22 outputs.

As a result, according to the fifth example embodiment, in the optical fiber sensing device 20, the load required for the process of converting the return light into the acoustic data and the process of identifying the position of production and the type of the sound source of the sound can be distributed to another device (the analysis device 31).

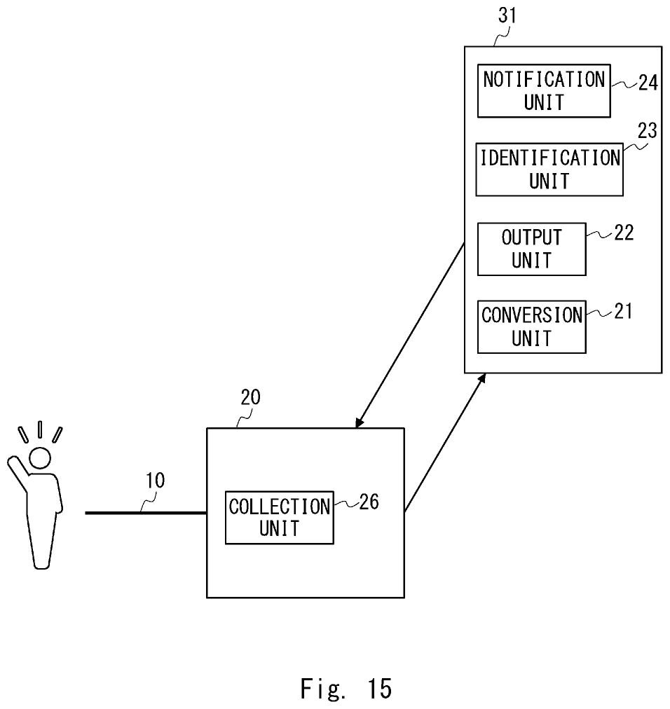

Note that, in the fifth example embodiment, among the constitutive elements provided in the optical fiber sensing device 20 of FIG. 4 of the second to fourth example embodiments described above, the conversion unit 21 and the identification unit 23 are provided in the separate device (analysis device 31); however, the present disclosure is not limited thereto. For example, as shown in FIG. 14, the output unit 22 may also be provided in the separate device (analysis device 31). Alternatively, as shown in FIG. 15, the notification unit 24, in addition to the output unit 22, may also be provided in the separate device (analysis device 31). In other words, the constitutive elements provided in the optical fiber sensing device 20 of FIG. 4 of the second to fourth example embodiments described above are not limited to being provided in a single device, and may be provided in a distributive manner in a plurality of devices.

Hereinafter, a specific application example of applying the optical fiber sensing system according to the above-described example embodiments to an acoustic system is described. In the following description, the acoustic system is exemplified by a conference system, a monitoring system, and a sound collection system; however, the acoustic system to which the optical fiber sensing system is applied is not limited thereto.

### First Application Example

The first application example is an example of applying the optical fiber sensing system according to the above-described example embodiments to a conference system. In particular, the first application example is an example of applying the optical fiber sensing system of the configuration of FIG. 4 of the second example embodiment described above.

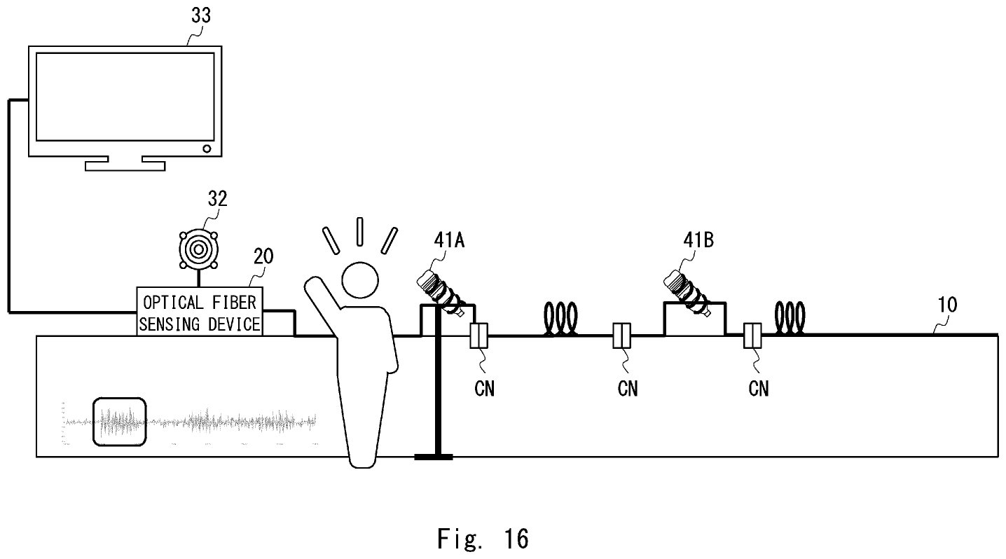

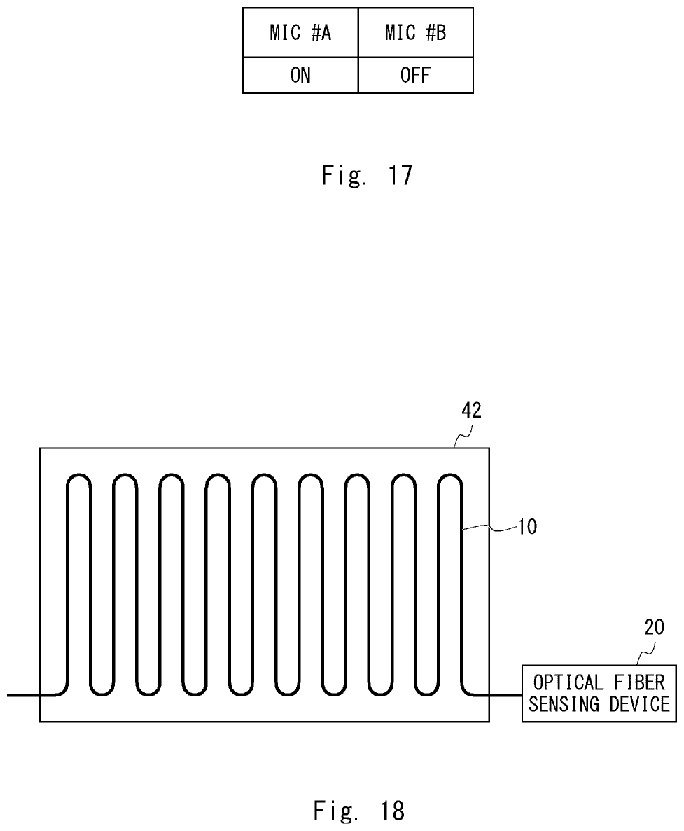

With reference to FIG. 16, a configuration example of the conference system according to the first application example is described.

As shown in FIG. 16, in the conference system according to the first application example, an object around which the optical fiber 10 is wound is used as a microphone (#A) 41A and a microphone (#B) 41B (hereinafter collectively referred to as “microphone 41” when no distinction is made between the microphone (#A) 41A and the microphone (#B)) 42B. In addition, a speaker 32 and a monitor 33 are connected to the optical fiber sensing device 20. Note that although the object around which the optical fiber 10 is wound is supposed to be a PET bottle in FIG. 16, the present disclosure is not limited thereto. In addition, although the object around which the optical fiber 10 is wound is used as the microphone 41, the microphone 41 is not limited to this example.

Examples of the microphone 41 include:

a cylindrical object with the optical fiber 10 wound therearound;

an object obtained by densely laying the optical fiber 10 in a predetermined shape (the shape of laying of the optical fiber 10 is not limited and may be, for example, a baton-like shape, a spiral shape, a star-like shape, etc.);

a box with the optical fiber 10 wound therearound; —an object with the optical fiber 10 wound therearound and covered; and

a box accommodating the optical fiber 10 (the optical fiber 10 is not necessarily required to be wound around the object, and may be, for example, accommodated in a box, embedded on a floor or a table, laid on a ceiling, etc.).

In the conference system according to the first application example, the sound detected by the microphone (#A) 41A and the microphone (#B) 41B are subjected to acoustic output from the speaker 32 or display output on the monitor 33.

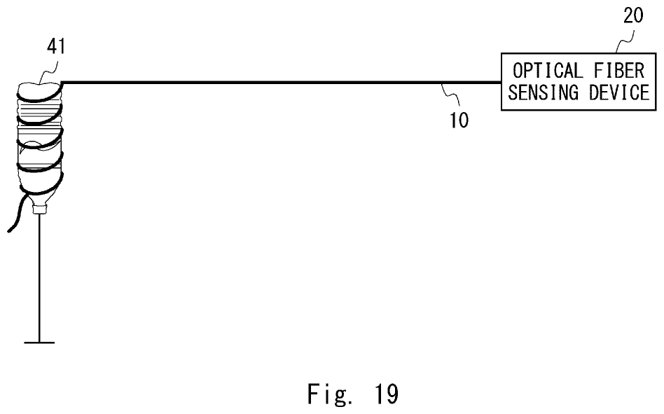

The microphone (#A) 41A and the microphone (#B) 41B allow switching of an ON/OFF status. For example, when the microphone (#A) 41A is turned off, the output unit 22 is prevented from outputting the sound detected by the microphone (#A) 41A, or the conversion unit 21 is prevented from converting the return light with the sound detected by the microphone (#A) 41A superimposed thereon into the acoustic data. In this case, the conversion unit 21 and the output unit 22 may determine whether or not the sound is the sound detected by the microphone (#A) 41A, on the basis of the position of production of the sound identified by the identification unit 23. Alternatively, the notification unit 24 may notify the ON/OFF statuses of the microphone (#A) 41A and the microphone (#B) 41B. At this time, the notification unit 24 may also carry out, for example, display output of the statuses of the microphone (#A) 41A and the microphone (#B) 41B on the monitor 33 as shown in FIG. 17.

In addition, in the conference system according to the first application example, the optical fiber 10 is connected through use of optical fiber connectors CN. For example, in a configuration of connecting the optical fiber 10 without using the optical fiber connector CN, there has been a problem of requiring use of a dedicated tool or a person with expertise for handling when the optical fiber 10 is disconnected or the like. Given this, connecting the optical fiber 10 by using the optical fiber connectors CN as in the first application example facilitates maintenance and equipment replacement in case of a failure.

### Second Application Example

The second application example is an example of applying the optical fiber sensing system according to the above-described example embodiments to a conference system carrying out a video conference involving a plurality of sites. In particular, the second application example is an example of applying the optical fiber sensing system of the configuration of FIG. 4 of the second example embodiment described above.

With reference to FIG. 18 to FIG. 21, an example of a laying procedure of the optical fiber 10 in the conference system according to the second application example is described. Note that, in FIG. 18 to FIG. 21, the table 42 is shown in a planar view and the microphone 41 is shown in a front view.

In the example of FIG. 18, the optical fiber 10 is laid evenly over the table 42 in a conference room. As a result, the sound can be detected in any location where the optical fiber 10 is laid, and thus any location on the table 42 on which the optical fiber 10 is laid functions as a microphone. The optical fiber 10 can thus detect voices of participants positioned around the table 42. Note that, in the following description, the participants positioned around the table 42 are supposed to be seated in chairs around the table 42. If the identification unit 23 holds in advance a correspondence table in which the position of the chair is associated with a distance of the optical fiber 10 from the position of the chair to the conversion unit 21, the position of the chair where the voice is produced, in other words the position of the chair in which the participant who speaks is seated, can be identified through use of the correspondence table. Note that although the optical fiber 10 is supposed to be laid on a tabletop of the table 42 in FIG. 18, the present disclosure is not limited thereto. The optical fiber 10 may also be laid on a lateral face or a lower face of the tabletop of the table 42, or embedded into the table 42. Alternatively, the optical fiber 10 may also be laid on a floor, a wall, a ceiling, or the like in the conference room.

In the example of FIG. 19, an object with the optical fiber 10 wound therearound is used as the microphone 41, the microphone 41 being arranged in the conference room. Note that, although the object around which the optical fiber 10 is wound is used as the microphone 41 in FIG. 19, the microphone 41 is not limited to this example. Examples of the microphone 41 are as described for the example in FIG. 16. In addition, in order to further increase sensitivity of the microphone 41 in FIG. 19, the optical fiber 10 may be wound more densely around the object.

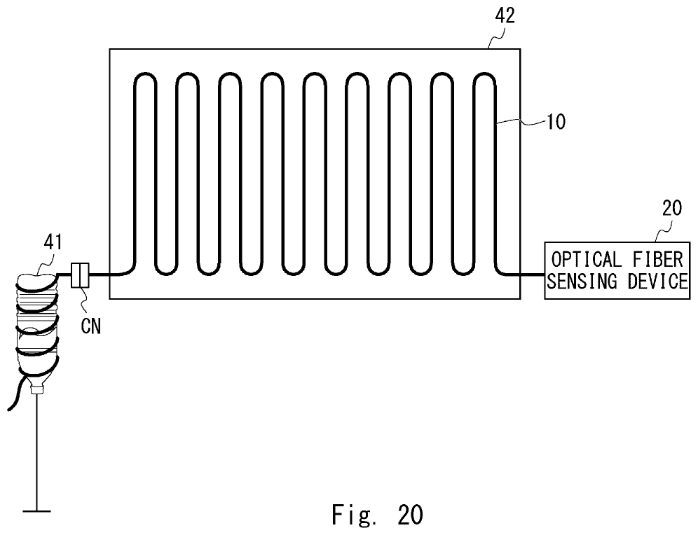

In the example of FIG. 20, FIG. 18 and FIG. 19 are combined. As a result, in addition to the object around which the optical fiber 10 is wound being usable as the microphone 41, any location on the table 42 on which the optical fiber 10 is laid can also be caused to function as a microphone.

In addition, in the example of FIG. 20, the optical fiber 10 on the table 42 side and the optical fiber 10 on the microphone 41 side are connected through use of the optical fiber connector CN. At this time, an end portion (end portion on a side opposite to the optical fiber sensing device 20) of the optical fiber 10 on the table 42 side is extended for connection with other configurations such as the microphone 41. This facilitates connection of other configurations to the optical fiber 10 on the table 42 side.

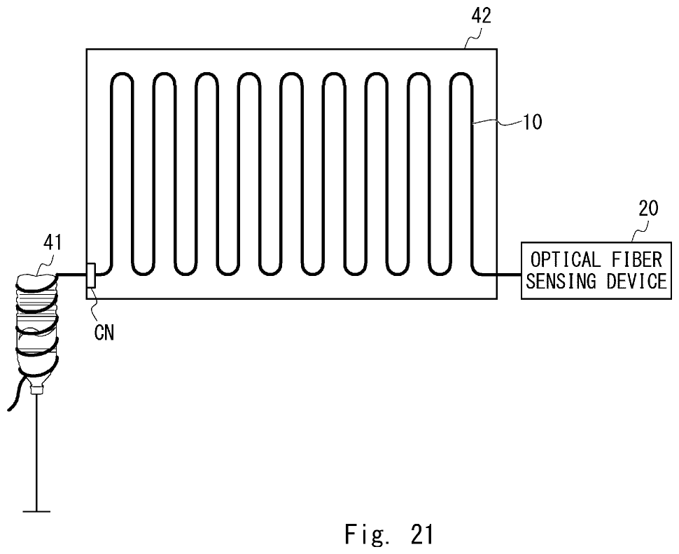

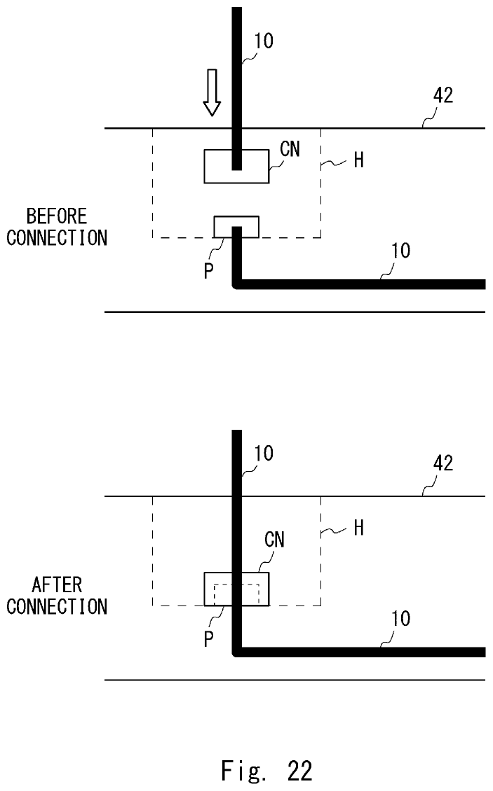

In addition, in the example of FIG. 21 as well, through combination of FIG. 18 and FIG. 19, the optical fiber 10 on the table 42 side and the optical fiber 10 on the microphone 41 side are connected through use of the optical fiber connector CN. Note that, the example of FIG. 21 is configured such that a slot P for the optical fiber connector CN is provided on the table 42 side, and the optical fiber connector CN of the optical fiber 10 on the microphone 41 side is inserted into the slot P. In this case, for example as shown in FIG. 22, a hole H with a bottom face is provided on the table 42 and the slot P is arranged on the bottom face. In the example of FIG. 22, the optical fiber 10 on the table 42 side is embedded inside the table 42 and connected to the slot P. The optical fiber 10 on the table 42 side and the optical fiber 10 on the microphone 41 side are connected through insertion of the optical fiber connector CN of the optical fiber 10 on the microphone 41 side into the slot P. Note that although the hole H is supposed to be provided on the table 42 in the example of FIG. 22, the hole H may also be provided on the lateral face of the table 42.

In this regard, all the examples of FIG. 18 to FIG. 21 are embodied by laying the single optical fiber 10.

For example, in a case of laying a plurality of optical fibers 10, a plurality of optical fiber sensing devices 20 must be provided to correspond to the plurality of optical fibers 10 respectively.

On the other hand, all the examples of FIG. 18 to FIG. 21 embodied by laying the single optical fiber 10 as described above obviate the need for providing a plurality of optical fiber sensing devices 20, and one optical fiber sensing device 20 suffices. Therefore, the examples of FIG. 18 to FIG. 21 make the configuration easier than in the case of providing a plurality of optical fiber sensing devices 20.

In addition, in all the examples of FIG. 18 to FIG. 21, the optical fiber 10 is connected through use of optical fiber connectors CN. Consequently, an area of the optical fiber 10 where an element wire is exposed is reduced, whereby a risk of disconnection and the like can be reduced.

Subsequently, a display example of a case of notifying, through display output, the position of production of sound and the type of the sound source in the conference system according to the second application example is described.

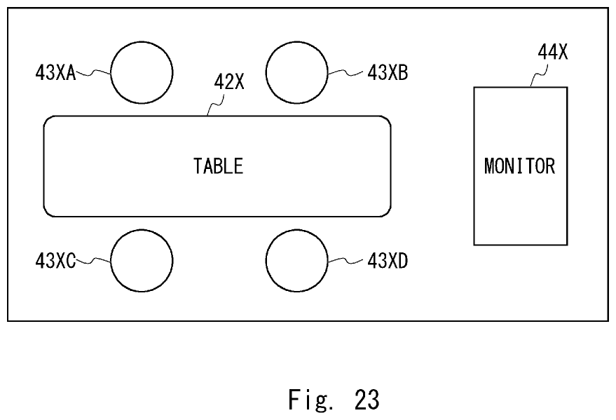

Hereinafter, suppose that a video conference is held between two sites X and Y, in which the position of production of sound and the type of the sound source detected by the optical fiber 10 in a conference room at the site X are subjected to display output on a monitor (hereinafter referred to as “monitor 44Y”) in a conference room at the site Y, while the position of production of sound and the type of the sound source detected by the optical fiber 10 in the conference room at the site Y are subjected to display output on a monitor 44X (see FIG. 23) in the conference room at the site X.

In addition, the following description exemplifies a case of carrying out display output of the position of production of sound and the type of a sound source detected by the optical fiber 10 in the conference room at the site X on the monitor 44Y in the conference room at the site Y. Suppose also that in the conference room at the site X, a table 42X, four chairs 43XA to 43XD, and the monitor 44X are arranged, and the participants are seated in the chairs 43XA to 43XD to participate in a conference as shown in FIG. 23. The chairs 43XA to 43XD are hereinafter collectively referred to as “chair 43X” when no distinction is made therebetween. Suppose also that the optical fiber 10 is laid evenly over the table 42X as shown in FIG. 18, and any location on the table 42X on which the optical fiber 10 is laid functions as a microphone.

### First Display Example in Second Application Example

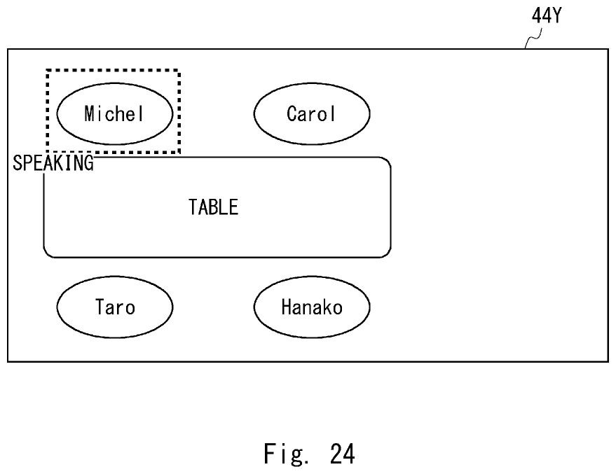

First, with reference to FIG. 24, a first display example in the second application example is described. Note that in the first display example in FIG. 24, voice of speech of the participants in the conference room at the site X is supposed to be subjected to acoustic output from a speaker (not illustrated) in the conference room at the site Y carried out by the output unit 22.

In the first display example in FIG. 24, the notification unit 24 carries out display output of the arrangement in the conference room at the site X on the monitor 44Y. Furthermore, when a participant speaks within the conference room at the site X, the notification unit 24 carries out display output of a frame border surrounding a position of production of voice of the participant (in this example, the position of the chair 43XA) on the monitor 44Y.

A procedure for embodying the first display example in FIG. 24 is, for example, as follows.

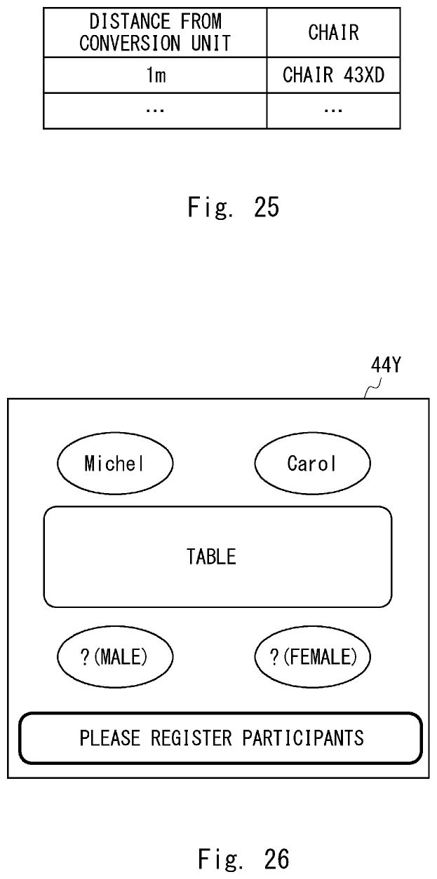

For example, the identification unit 23 holds in advance a correspondence table in which positions of the chairs 43XA to 43XD are associated with respective distances of the optical fiber 10 from the positions of the chairs 43XA to 43XD to the conversion unit 21 (see FIG. 25). When a participant speaks, the identification unit 23 identifies the distance of the optical fiber 10 from the position of production of the voice of the participant to the conversion unit 21, and then uses the correspondence table to identify the position of the chair 43X corresponding to the distance thus identified. The notification unit 24 carries out display output of the arrangement in the conference room at the site X. Furthermore, when a participant speaks, the notification unit 24 carries out display output of a frame border surrounding the position of the chair 43X identified by the identification unit 23.

In addition, in the first display example in FIG. 24, the notification unit 24 carries out display output of names of the participants seated in the chairs 43XA to 43XD in the conference room at the site X on the monitor 44Y.

A procedure for obtaining the names of the participants seated in the chairs 43XA to 43XD is, for example, as follows.

For example, the identification unit 23 holds in advance acoustic data of voice of each of a plurality of persons as teacher data in association with respective names and the like of the plurality of persons. Note that the teacher data may also have been learned by the identification unit 23 through machine learning or the like. When a participant speaks, the identification unit 23 identifies, as described above, the position of the chair 43X in which the participant is seated. In addition, the identification unit 23 compares the pattern of the acoustic data of the voice of the participant with each of the patterns of the plurality of pieces of the teacher data. When a pattern of any of the teacher data is matched, the identification unit 23 obtains a name of a person associated with the matched teacher data as the name of the participant seated in the chair 43X thus identified.

Alternatively, the identification unit 23 may prompt the participants to register their names as shown in FIG. 26. In this regard, the identification unit 23 may also detect facial images in a captured image of the inside of the conference room at the site X captured by an imaging unit (not illustrated) through use of face recognition technology prior to the start of the conference, and prompt all of the participants of which facial images have been detected to register their names. Alternatively, the identification unit 23 may also attempt to obtain names of all of the participants of which facial images have been detected in the captured image upon their speech during the conference through use of the above-described teacher data of the acoustic data, and prompt only the participants of which name could not be obtained to register their names.

Yet alternatively, the identification unit 23 may also carry out voice recognition of voice of the participants during the conference, analyze content of speech on the basis of results of the voice recognition, and obtain names of the participants on the basis of the content of speech enabling identification of the participants (for example, “What do you think, Mr. XX?”).

Note that the identification unit 23 may also analyze acoustic data of the participants during the conference, and hold the acoustic data as teacher data in association with the names and the like of the participants. This enables the acoustic data of the participants not having been held as the teacher data to be newly held as the teacher data, and teacher data to be further accumulated for the acoustic data of the participants having been held as the teacher data, whereby the teacher data can be improved in accuracy. As a result, when the participants participate in subsequent conferences, this enables the participants to be smoothly identified and their names to be smoothly obtained.

### Second Display Example in Second Application Example

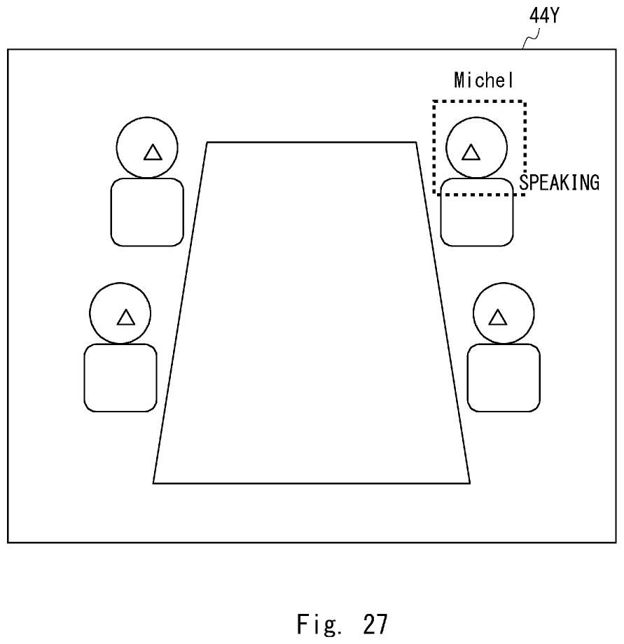

Subsequently, with reference to FIG. 27, a second display example in the second application example is described. Note that in the second display example in FIG. 27, voice of speech of the participants in the conference room at the site X is supposed to be subjected to acoustic output carried out by the output unit 22 from a speaker (not illustrated) in the conference room at the site Y.

In the second display example in FIG. 27, the notification unit 24 carries out display output of a captured image of the inside of the conference room at the site X, captured by an imaging unit (not illustrated), on the monitor 44Y. The captured image corresponds to an image obtained by capturing the table 42X and its surroundings from the position of the monitor 44X in FIG. 23. Note that the captured image is not limited to that of FIG. 23, and may be of any angle as long as facial images of all of the participants are included. Furthermore, when a participant speaks within the conference room at the site X, the notification unit 24 carries out display output of a frame border surrounding the facial image of the participant on the monitor 44Y.

A procedure for embodying the second display example in FIG. 27 is, for example, as follows.

For example, the identification unit 23 holds in advance a correspondence table in which positions of the chairs 43XA to 43XD are associated with respective distances of the optical fiber 10 from the positions of the chairs 43XA to 43XD to the conversion unit 21 (see FIG. 25). When a participant speaks, the identification unit 23 identifies the distance of the optical fiber 10 from the position of production of the voice of the participant to the conversion unit 21, and then uses the correspondence table to identify the position of the chair 43X corresponding to the distance thus identified. In addition, the identification unit 23 holds arrangement data of the inside of the conference room at the site X in order to enable determination of which parts of the captured image of the inside of the conference room at the site X correspond to the chairs 43XA to 43XD respectively. And then the identification unit 23 detects facial images in the captured image of the inside of the conference room at the site X through use of face recognition technology, and, among the facial images thus detected, identifies a facial image in the position closest to the position of the chair 43X identified as described above. The notification unit 24 carries out display output of the captured image of the inside of the conference room at the site X. Furthermore, when a participant speaks, the notification unit 24 carries out display output of a frame border surrounding the facial image identified by the identification unit 23.

In addition, in the second display example in FIG. 27, the notification unit 24 also carries out display output of the name of the participant (in this example, Michel) seated in the chair 43X identified as described above on the monitor 44Y.

Note that a procedure for obtaining the name of the participant seated in the chair 43X may be similar to that of the above-described first display example, and the description thereof is therefore omitted.

### Third Display Example in Second Application Example

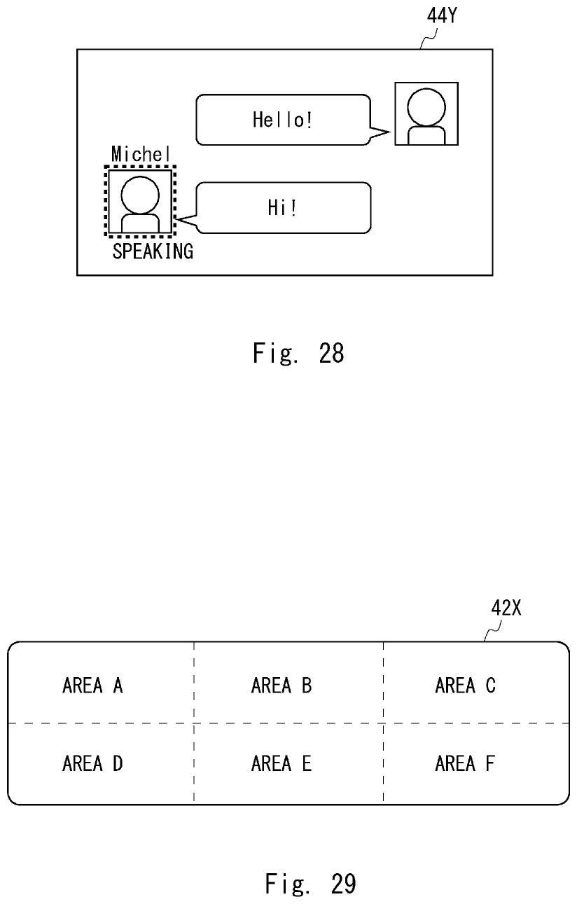

Subsequently, with reference to FIG. 28, a third display example in the second application example is described.

In the third display example in FIG. 28, when a participant speaks within the conference room at the site X, the output unit 22 carries out display output of the voice of the participant on the monitor 44Y. At this time, the notification unit 24 carries out display output of the facial image of the participant on the monitor 44Y, along with the voice subjected to display output by the output unit 22. In other words, in the third display example in FIG. 28, for example, the voice and the facial images of the participants are subjected to display output just like a chat. Note that in the third display example in FIG. 28, the latest voice is subjected to display output in the lowermost position.

A procedure for embodying the third display example in FIG. 28 is, for example, as follows.

For example, when a participant speaks, the output unit 22 carries out display output of the voice of the participant. The identification unit 23 holds in advance a correspondence table in which positions of the chairs 43XA to 43XD are associated with respective distances of the optical fiber 10 from the positions of the chairs 43XA to 43XD to the conversion unit 21 (see FIG. 25). When a participant speaks, the identification unit 23 identifies the distance of the optical fiber 10 from the position of production of the voice of the participant to the conversion unit 21, and then uses the correspondence table to identify the position of the chair 43X corresponding to the distance thus identified. Furthermore, the identification unit 23 obtains the facial image of the participant seated in the chair 43X identified as described above. When a participant speaks, the notification unit 24 carries out display output of the facial image obtained by the identification unit 23.

A procedure for obtaining the facial image of the participant is, for example, as follows.

The identification unit 23 holds arrangement data of the inside of the conference room at the site X in order to enable determination of which parts of the captured image of the inside of the conference room at the site X correspond to the chairs 43XA to 43XD respectively. When a participant speaks, the identification unit 23 identifies the position of the chair 43X in which the participant is seated as described above. And then the identification unit 23 detects facial images in the captured image of the inside of the conference room at the site X through use of face recognition technology, and, among the facial images thus detected, obtains a facial image in the position closest to the position of the chair 43X as the facial image of the participant seated in the chair 43X identified as described above.

Alternatively, the identification unit 23 holds in advance acoustic data of voice of each of a plurality of persons as teacher data in association with respective names, facial images and the like of the plurality of persons. Note that the teacher data may also have been learned by the identification unit 23 through machine learning or the like. When a participant speaks, the identification unit 23 identifies the position of the chair 43X in which the participant is seated as described above. In addition, the identification unit 23 compares the pattern of the acoustic data of the voice of the participant with each of the patterns of the plurality of pieces of the teacher data. When a pattern of any of the teacher data is matched to a pattern of the acoustic data of the voice of the participant, the identification unit 23 obtains a facial image of a person associated with the matched teacher data as the facial image of the participant seated in the chair 43X identified as described above.

In addition, in the third display example in FIG. 28, the notification unit 24 also carries out display output of the name of the participant (in this example, Michel) seated in the chair 43X identified as described above on the monitor 44Y.

Note that a procedure for obtaining the name of the participant seated in the chair 43X identified as described above may be similar to that of the above-described first display example, and the description thereof is therefore omitted.

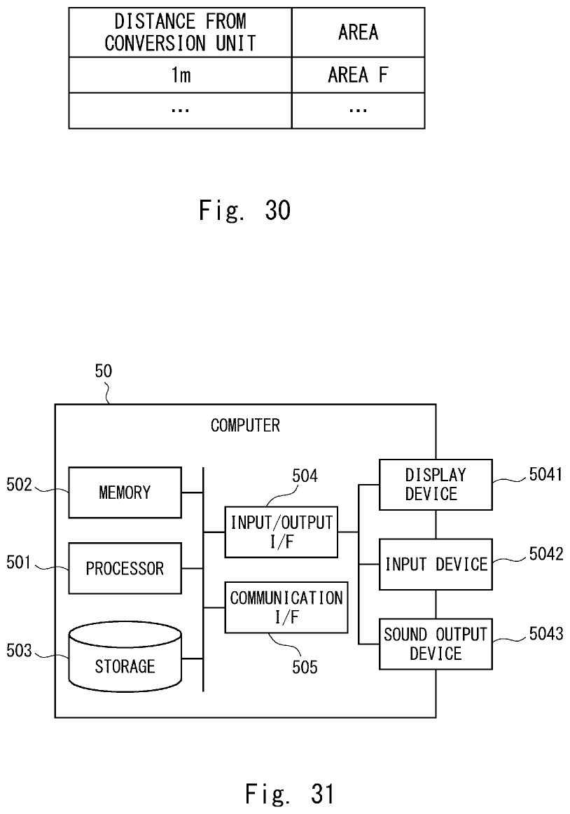

Note that, in the description of the second application example, the participants positioned around the table 42X have been supposed to be seated in chairs 43X around the table 42X; however, the chairs 43X are not necessarily fixed. Therefore, as shown in FIG. 29, the table 42X may be divided into a plurality of areas (in this example, areas A to F), and, when a participant speaks, the identification unit 23 may identify the position of an area where voice of the participant is produced, in other words the position of an area where the participant who speaks is present. In this case, if the identification unit 23 holds in advance a correspondence table (see FIG. 30) in which the position of the area is associated with a distance of the optical fiber 10 from the position of the area to the conversion unit 21, the position of the area where the voice is produced, in other words the position of the area in which the participant who speaks is present, may be identified through use of the correspondence table.

### Third Application Example

The third application example is an example of applying the optical fiber sensing system according to the above-described example embodiments to a monitoring system. In particular, the third application example is an example of applying the optical fiber sensing system of the configuration of FIG. 4 of the second example embodiment described above.

A monitoring area to be monitored by the monitoring system is, for example, a border, a prison, a commercial facility, an airport, a hospital, streets, a port, a plant, a nursing home, company premises, a nursery school, a private home, or the like.

Hereinafter, in the case of the monitoring area being a nursery school, an example of the monitoring system allowing a parental guardian to connect to the monitoring system through an application on a mobile terminal such as a smartphone, to check the condition of a child by means of the child's voice is described.

In the nursery school, the optical fiber 10 is laid on a floor, walls, a ceiling, and the like inside a building.

In addition, the identification unit 23 holds in advance acoustic data of voice of each of a plurality of children who are pupils of the nursery school as teacher data in association with respective identification information (names, identification numbers, etc.) of parental guardians of the children. Note that the teacher data may also have been learned by the identification unit 23 through machine learning or the like.

When a parental guardian uses the monitoring system, the following operations are made.

First, the parental guardian connects to the monitoring system through an application on a mobile terminal and submits identification information of the parental guardian.

Upon reception of the identification information from the parental guardian, the identification unit 23 identifies, among the teacher data held in advance, the acoustic data of voice of a child of the parental guardian associated with the identification information.

And then, when the optical fiber 10 detects sound in the nursery school, the identification unit 23 compares the pattern of acoustic data of the sound with the pattern of the acoustic data identified as described above. When the pattern of the acoustic data of the sound detected by the optical fiber 10 is matched to the pattern of the acoustic data identified as described above, the identification unit 23 extracts the acoustic data of the sound detected by the optical fiber 10 as the acoustic data of the voice of the child of the parental guardian.

The output unit 22 carries out acoustic output of the voice of the child from a speaker and the like of the mobile terminal, on the basis of the acoustic data extracted by the identification unit 23.

At this time, it is preferred that the output unit 22 does not output voices other than that of the child of the parental guardian. This prevents voices of children other than the child of the parental guardian and nursery staff members from being output, whereby privacy of others is protected.

Note that, in the above description, the identification unit 23 extracts the acoustic data of the child of the parental guardian through use of pattern matching; however, the present disclosure is not limited thereto. For example, the identification unit 23 may also use voice recognition technology to extract the acoustic data of the child of the parental guardian. When the voice recognition technology is used, the following operations are made.

The identification unit 23 holds in advance a characteristic feature of acoustic data of voice of each of a plurality of children who are pupils of the nursery school in association with respective identification information (names, identification numbers, etc.) of parental guardians of the children. Note that the characteristic feature of the acoustic data may also be learned by the identification unit 23 through machine learning or the like.

Upon reception of the identification information from the parental guardian, the identification unit 23 identifies, among the characteristic features of the acoustic data held in advance, the characteristic feature of the acoustic data of voice of a child of the parental guardian associated with the identification information.

And then, when the optical fiber 10 detects sound in the nursery school, the identification unit 23 compares a characteristic feature of acoustic data of the sound with the characteristic feature of the acoustic data identified as described above. When the characteristic feature of the acoustic data of the sound detected by the optical fiber 10 is matched to the characteristic feature of the acoustic data identified as described above, the identification unit 23 extracts the acoustic data of the sound detected by the optical fiber 10 as the acoustic data of the voice of the child of the parental guardian.

### Fourth Application Example

The fourth application example is an example of applying the optical fiber sensing system according to the above-described example embodiments to a sound collection system. In particular, the third application example is an example of applying the optical fiber sensing system of the configuration of FIG. 4 of the second example embodiment.

A sound collection area in which the sound collection system collects sound is, for example, an area where a marked person is likely to appear, such as a border, a prison, a station, an airport, religious facilities, monitoring facilities, or the like.

Hereinafter, an example of the sound collection system configured to collect voice of the marked person in the sound collection area is described.

In the sound collection area, the optical fiber 10 is laid on a floor, walls and a ceiling inside a building, as well as in the ground and on a fence outside the building, and the like.

When the sound collection system collects voice of the marked person, the following operations are made.

The identification unit 23 identifies the marked person. For example, when a suspicious person detection system (not illustrated) or the like analyzes behavior and the like of a person being present in the sound collection area to identify a suspicious person, the identification unit 23 identifies the suspicious person as the marked person.

Subsequently, the identification unit 23 identifies a position of the marked person (a distance of the optical fiber 10 from the position to the conversion unit 21) in cooperation with the suspicious person detection system or the like.

And then, the conversion unit 21 converts the return light with the sound, which is detected by the optical fiber 10 in the position identified by the identification unit 23, superimposed thereon into acoustic data. The identification unit 23 analyzes a dynamic change in the pattern of the acoustic data to extract the acoustic data of voice of the marked person (voice during conversation with another marked person and the like).

The output unit 22 carries out acoustic output or display output of the voice of the marked person to a security system or a security guards' room, on the basis of the acoustic data extracted by the identification unit 23. Alternatively, the notification unit 24 may also notify the security system or the security guards' room of the detection of the marked person.

### <Hardware Configuration of Optical Fiber Sensing Device>

Subsequently, a hardware configuration of a computer 50 embodying the optical fiber sensing device 20 is described hereinafter with reference to FIG. 31. The following description exemplifies a case of embodying the optical fiber sensing device 20 of the configuration of FIG. 4 of the second example embodiment described above.

As shown in FIG. 31, the computer 50 is provided with a processor 501, memory 502, a storage 503, an input/output interface (input/output I/F) 504, and a communication interface (communication I/F) 505, and the like. The processor 501, the memory 502, the storage 503, the input/output interface 504, and the communication interface 505 are connected with each other via a data transmission channel configured to send and receive data.

The processor 501 is, for example, an arithmetic processing unit such as a CPU (Central Processing Unit) and a GPU (Graphics Processing Unit). The memory 502 is, for example, memory such as RAM (Random Access Memory) and ROM (Read Only Memory). The storage 503 is, for example, a storage device such as an HDD (Hard Disk Drive), an SSD (Solid State Drive), or a memory card. Alternatively, the storage 503 may be memory such as RAM and ROM.

The storage 503 stores programs configured to embody the functions of constitutive elements (the conversion unit 21, the output unit 22, the identification unit 23, and the notification unit 24) provided in the optical fiber sensing device 20. The processor 501 executes these programs to realize the respective functions of the constitutive elements provided in the optical fiber sensing device 20. In this regard, upon execution of each of the above-described programs, the processor 501 may either read these programs into the memory 502 for execution, or execute these programs without reading into the memory 502. In addition, the memory 502 and the storage 503 also serve to store the information and the data held by the constitutive elements provided in the optical fiber sensing device 20. Furthermore, the memory 502 and the storage 503 also serve as the storage unit 25 in FIG. 3.

The aforementioned programs may also be provided to a computer (including the computer 50) in a state of being stored by using various types of non-transitory computer-readable media. The non-transitory computer-readable medium includes various types of tangible storage media. Examples of the non-transitory computer-readable medium include: a magnetic recording medium (for example, a flexible disk, a magnetic tape, or a hard disk drive); a magneto-optical recording medium (for example, a magneto-optical disk); a CD-ROM (Compact Disc-ROM); a CD-R (CD-Recordable); a CD-R/W (CD-ReWritable); and semiconductor memory (for example, mask ROM, PROM (Programmable ROM), EPROM (Erasable PROM), flash ROM, or RAM). Alternatively, the programs may be provided to the computer by means of various types of transitory computer-readable media. Examples of the transitory computer-readable medium include an electrical signal, an optical signal, and an electromagnetic wave. The transitory computer-readable media can provide the program to a computer via a wired communication channel such as an electric wire and a fiber-optic cable, or a wireless communication channel.

The input/output interface 504 is connected to a display device 5041, an input device 5042, a sound output device 5043 and the like. The display device 5041 is a device such as an LCD (Liquid Crystal Display), a CRT (Cathode Ray Tube) display, and a monitor, configured to display a screen corresponding to drawing data processed by the processor 501. The input device 5042 is a device, for example, a keyboard, a mouse, a touch sensor, and the like configured to accept an operation input from an operator. The display device 5041 and the input device 5042 may be integrally embodied as a touch panel. The sound output device 5043 is a device such as a speaker configured to carry out acoustic output of sound corresponding to acoustic data processed by the processor 501.

The communication interface 505 sends and receives data with respect to external devices. For example, the communication interface 505 communicates with the external devices via a wired communication channel or a wireless communication channel.

The present disclosure has been described with reference to the example embodiments; however, the present disclosure is not limited to the above-described example embodiments. Various modifications comprehensible by one of ordinary skill in the art within the scope of the present disclosure can be made to the configurations and details of the present disclosure.

A part or all of the above-described example embodiment may be stated as in the supplementary note presented below, but is not limited thereto.

### (Supplementary Note 1)

An optical fiber sensing system comprising:

an optical fiber configured to transmit an optical signal with sound superimposed thereon;

a conversion unit configured to convert the optical signal into acoustic data; and

an output unit configured to output the sound on the basis of the acoustic data.

### (Supplementary Note 2)

The optical fiber sensing system according to Supplementary Note 1, further comprising:

an identification unit configured to identify a position of production of the sound on the basis of the optical signal; and

a notification unit configured to notify, when the output unit outputs the sound, the position of production of the sound in association with the sound that the output unit outputs.

### (Supplementary Note 3)

The optical fiber sensing system according to Supplementary Note 2, wherein

the identification unit identifies a type of a sound source of the sound on the basis of a pattern of the acoustic data; and

the notification unit notifies, when the output unit outputs the sound, the position of production of the sound and the type of the sound source of the sound in association with the sound that the output unit outputs.

### (Supplementary Note 4)

The optical fiber sensing system according to Supplementary Note 3, wherein

the identification unit identifies, regarding each of a plurality of pieces of sound from different positions of production, the type of the sound source of the sound; and

the notification unit notifies, regarding each of the plurality of pieces of sound from different positions of production, when the output unit outputs the sound, the position of production of the sound and the type of the sound source of the sound in association with the sound that the output unit outputs.

### (Supplementary Note 5)

The optical fiber sensing system according to Supplementary Note 3 or 4, further comprising a storage unit configured to store the acoustic data,

wherein the output unit reads the acoustic data from the storage unit and outputs the sound on the basis of the acoustic data thus read.

### (Supplementary Note 6)

The optical fiber sensing system according to Supplementary Note 5, wherein the storage unit stores the position of production of the sound and the type of the sound source of the sound in association with the acoustic data, and

when the output unit outputs the sound, the notification unit reads the position of production of the sound and the type of the sound source of the sound from the storage unit and notifies the position of production of the sound and the type of the sound source of the sound thus read in association with the sound that the output unit outputs.

### (Supplementary Note 7)

The optical fiber sensing system according to any one of Supplementary Notes 1 to 6, further comprising an object configured to accommodate the optical fiber,

wherein the optical fiber transmits the optical signal with the sound, which is produced around the object, superimposed thereon.

### (Supplementary Note 8)

An optical fiber sensing device comprising:

a conversion unit configured to convert an optical signal with sound superimposed thereon transmitted through an optical fiber into acoustic data; and

an output unit configured to output the sound on the basis of the acoustic data.

### (Supplementary Note 9)

The optical fiber sensing device according to Supplementary Note 8, further comprising:

an identification unit configured to identify a position of production of the sound on the basis of the optical signal; and

a notification unit configured to notify, when the output unit outputs the sound, the position of production of the sound in association with the sound that the output unit outputs.

### (Supplementary Note 10)

The optical fiber sensing device according to Supplementary Note 9, wherein

the identification unit identifies a type of a sound source of the sound on the basis of a pattern of the acoustic data; and

the notification unit notifies, when the output unit outputs the sound, the position of production of the sound and the type of the sound source of the sound in association with the sound that the output unit outputs.

### (Supplementary Note 11)

The optical fiber sensing device according to Supplementary Note 10, wherein

the identification unit identifies, regarding each of a plurality of pieces of sound from different positions of production, the position of production of the sound and the type of the sound source of the sound; and

the notification unit notifies, regarding each of the plurality of pieces of sound from different positions of production, when the output unit outputs the sound, the position of production of the sound and the type of the sound source of the sound in association with the sound that the output unit outputs.

### (Supplementary Note 12)

The optical fiber sensing device according to any one of Supplementary Notes 7 to 11, further comprising a storage unit configured to store the acoustic data,

wherein the output unit reads the acoustic data from the storage unit and outputs the sound on the basis of the acoustic data thus read.

### (Supplementary Note 13)

The optical fiber sensing device according to Supplementary Note 12, wherein the storage unit stores the position of production of the sound and the type of the sound source of the sound in association with the acoustic data, and

when the output unit outputs the sound, the notification unit reads the position of production of the sound and the type of the sound source of the sound from the storage unit and notifies the position of production of the sound and the type of the sound source of the sound thus read in association with the sound that the output unit outputs.

### (Supplementary Note 14)

The optical fiber sensing device according to any one of Supplementary Notes 8 to 13, wherein the optical fiber transmits the optical signal with the sound, which is produced around an object accommodating the optical fiber, superimposed thereon.

### (Supplementary Note 15)

A sound output method by an optical fiber sensing system comprising:

a transmitting step in which an optical fiber transmits an optical signal with sound superimposed thereon;

a conversion step of converting the optical signal into acoustic data; and

an output step of outputting the sound on the basis of the acoustic data.

### (Supplementary Note 16)

The sound output method according to Supplementary Note 15, further comprising:

an identification step of identifying a position of production of the sound on the basis of the optical signal; and

a notification step of notifying, when the sound is output in the output step, the position of production of the sound in association with the sound that is output in the output step.

### (Supplementary Note 17)

The sound output method according to Supplementary Note 16, wherein

in the identification step, a type of a sound source of the sound is identified on the basis of a pattern of the acoustic data, and

in the notification step, when the sound is output in the output step, the position of production of the sound and the type of the sound source of the sound are notified in association with the sound that is output in the output step.

### (Supplementary Note 18)

The sound output method according to Supplementary Note 17, wherein

in the identification step, regarding each of a plurality of pieces of sound from different positions of production, the type of the sound source of the sound is identified; and

in the notification step, regarding each of the plurality of pieces of sound from different positions of production, when the sound is output in the output step, the position of production of the sound and the type of the sound source of the sound are notified in association with the sound that is output in the output step.

### (Supplementary Note 19)

The sound output method according to Supplementary Note 17 or 18, further comprising a storage step of storing the acoustic data,

wherein in the output step, the acoustic data thus stored is read and the sound is output on the basis of the acoustic data thus read.

### (Supplementary Note 20)

The sound output method according to Supplementary Note 19, wherein in the storage step, the position of production of the sound and the type of the sound source of the sound are stored in association with the acoustic data, and

in the notification step, when the sound is output in the output step, the position of production of the sound and the type of the sound source of the sound thus stored are read, and the position of production of the sound and the type of the sound source of the sound thus read are notified in association with the sound that is output in the output step.

### (Supplementary Note 21)

The sound output method according to any one of Supplementary Notes 15 to 21, wherein in the transmitting step, the optical fiber transmits the optical signal with the sound, which is produced around an object accommodating the optical fiber, superimposed thereon.

### REFERENCE SIGNS LIST

10 OPTICAL FIBER
20 OPTICAL FIBER SENSING DEVICE
21 CONVERSION UNIT
22 OUTPUT UNIT
23 IDENTIFICATION UNIT
24 NOTIFICATION UNIT
25 STORAGE UNIT
26 COLLECTION UNIT
31 ANALYSIS DEVICE
32 SPEAKER
33 MONITOR
41, 41A, 41B MICROPHONE
42, 42X TABLE
43XA TO 43XD CHAIR
44X, 44Y MONITOR
50 COMPUTER
501 PROCESSOR
502 MEMORY
503 STORAGE
504 INPUT/OUTPUT INTERFACE
5041 DISPLAY DEVICE
5042 INPUT DEVICE
5043 SOUND OUTPUT DEVICE
505 COMMUNICATION INTERFACE

What is claimed is:

1. An optical fiber sensing system comprising:
an optical fiber configured to transmit an optical signal with sound superimposed thereon;
a conversion unit configured to convert the optical signal into acoustic data; and
an output unit configured to output the sound on the basis of the acoustic data.

2. The optical fiber sensing system according to claim 1, further comprising:
an identification unit configured to identify a position of production of the sound on the basis of the optical signal; and
a notification unit configured to notify, when the output unit outputs the sound, the position of production of the sound in association with the sound that the output unit outputs.

3. The optical fiber sensing system according to claim 2, wherein
the identification unit identifies a type of a sound source of the sound on the basis of a pattern of the acoustic data; and
the notification unit notifies, when the output unit outputs the sound, the position of production of the sound and the type of the sound source of the sound in association with the sound that the output unit outputs.

4. The optical fiber sensing system according to claim 3, wherein
the identification unit identifies, regarding each of a plurality of pieces of sound from different positions of production, the type of the sound source of the sound; and
the notification unit notifies, regarding each of the plurality of pieces of sound from different positions of production, when the output unit outputs the sound, the position of production of the sound and the type of the sound source of the sound in association with the sound that the output unit outputs.

5. The optical fiber sensing system according to claim 3, further comprising a storage unit configured to store the acoustic data,
wherein the output unit reads the acoustic data from the storage unit and outputs the sound on the basis of the acoustic data thus read.

6. The optical fiber sensing system according to claim 1, further comprising an object configured to accommodate the optical fiber,
wherein the optical fiber transmits the optical signal with the sound, which is produced around the object, superimposed thereon.

7. An optical fiber sensing device comprising:
a conversion unit configured to convert an optical signal with sound superimposed thereon transmitted through an optical fiber into acoustic data; and
an output unit configured to output the sound on the basis of the acoustic data.

8. The optical fiber sensing device according to claim 7, further comprising:
an identification unit configured to identify a position of production of the sound on the basis of the optical signal; and
a notification unit configured to notify, when the output unit outputs the sound, the position of production of the sound in association with the sound that the output unit outputs.

9. The optical fiber sensing device according to claim 8, wherein
the identification unit identifies a type of a sound source of the sound on the basis of a pattern of the acoustic data; and
the notification unit notifies, when the output unit outputs the sound, the position of production of the sound and the type of the sound source of the sound in association with the sound that the output unit outputs.

10. The optical fiber sensing device according to claim 9, wherein
the identification unit identifies, regarding each of a plurality of pieces of sound from different positions of production, the position of production of the sound and the type of the sound source of the sound; and
the notification unit notifies, regarding each of the plurality of pieces of sound from different positions of production, when the output unit outputs the sound, the position of production of the sound and the type of the sound source of the sound in association with the sound that the output unit outputs.

11. The optical fiber sensing device according to claim 9, further comprising a storage unit configured to store the acoustic data,
wherein the output unit reads the acoustic data from the storage unit and outputs the sound on the basis of the acoustic data thus read.

12. The optical fiber sensing device according to claim 7, wherein the optical fiber transmits the optical signal with the sound, which is produced around an object accommodating the optical fiber, superimposed thereon.

13. A sound output method by an optical fiber sensing system comprising:
a transmitting step in which an optical fiber transmits an optical signal with sound superimposed thereon;
a conversion step of converting the optical signal into acoustic data; and
an output step of outputting the sound on the basis of the acoustic data.

14. The sound output method according to claim 13, further comprising:
an identification step of identifying a position of production of the sound on the basis of the optical signal; and
a notification step of notifying, when the sound is output in the output step, the position of production of the sound in association with the sound that is output in the output step.

15. The sound output method according to claim 14, wherein
in the identification step, a type of a sound source of the sound is identified on the basis of a pattern of the acoustic data, and
in the notification step, when the sound is output in the output step, the position of production of the sound and the type of the sound source of the sound are notified in association with the sound that is output in the output step.

16. The sound output method according to claim 15, wherein
in the identification step, regarding each of a plurality of pieces of sound from different positions of production, the type of the sound source of the sound is identified; and
in the notification step, regarding each of the plurality of pieces of sound from different positions of production, when the sound is output in the output step, the position of production of the sound and the type of the sound source of the sound are notified in association with the sound that is output in the output step.

17. The sound output method according to claim 15, further comprising a storage step of storing the acoustic data,
wherein in the output step, the acoustic data thus stored is read and the sound is output on the basis of the acoustic data thus read.

18. The sound output method according to claim 13, wherein in the transmitting step, the optical fiber transmits the optical signal with the sound, which is produced around an object accommodating the optical fiber, superimposed thereon.
